(19) United States
(12) Patent Application Publication
(10) Pub. No.: US 2018/0239690 A1
(43) Pub. Date: Aug. 23, 2018

(54) Management of Problems in Software Programs

(71) Applicant: International Business Machines Corporation, Armonk, NY (US)

(72) Inventors: Luca Balestrazzi, Rome (IT); Fabio De Angelis, Rome (IT); Andrea Napoleoni, Rome (IT); Stefano Sidoti, Rome (IT)

(21) Appl. No.: 15/439,333

(22) Filed: Feb. 22, 2017

(51) Int. Cl. G06F 11/36

(52) U.S. Cl. CPC G06F 11/366; G06F 11/3672

(57) ABSTRACT

A mechanism is provided for managing problems in a software product installed on a plurality of computing machines. Tracking information of one or more problems being solved on corresponding ones of the plurality of computing machines is received. One or more solution models are established according to the tracking information. Corresponding diagnostic reports are collected from the computing machines according to the solution models, the diagnostic report of each computing machine indicating of any of the problems of the solution models occurring on the computing machine and a set of collected values of any diagnostic parameters of the solution models available on the computing machine. A determination is made of any applicable solutions for each of the computing machines according to a comparison of the diagnostic report of the computing machine with the solution models. Each of the plurality of computing machines then applies the corresponding applicable solutions.

### BACKGROUND

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

The present disclosure relates to the information technology field. More specifically, this disclosure relates to the management of problems in software products.

Software products inevitably suffer a number of problems over time (from simple degradations of performance to severe errors, either temporary or permanent); this is especially true in complex environments, wherein multiple software products interact among them. Whenever this happens, diagnostics activities are performed in an attempt to identify the cause of any problem and to solve it (by either fixing the problem or simply bypassing it).

For this purpose, Problem Tracking Systems (PTSs) or Issue Tracking Systems (ITSs) are commonly used to manage the diagnostics activities. A typical example is in a customer support center of a vendor of one or more software products, which provides support for the software products to customers thereof. Particularly, each customer may contact the customer support center to submit a support request for any problem (or issue) that is experienced in a specific software product; the support request is captured by the customer support center with the opening of a corresponding ticket that provides a running report thereof. The tickets are allocated to operators of the customer support center for their management. For each ticket, the corresponding operator collects diagnostic information about the problem from the customer (for example, a problem code returned by the software product, information about a software/hardware environment of the customer and a configuration thereof) and enters it into the tracking support system. The tickets are then served (according to corresponding scheduling policy) trying to solve the corresponding problems. As soon as any problem is solved, the corresponding ticket is closed by entering an indication of the solution that has been applied.

Different techniques are available to facilitate the solutions of the problems experienced in the software products. For example, the problem tracking system is often provided with a knowledge base containing information on solutions that have been applied to common problems in the past and then may be applied to any further occurrences thereof. Moreover, U.S. Pat. No. 9,026,856 discloses a specific technique for resolving and/or assisting users in resolving problems. One common embodiment involves software problems, such as an error during installation of a software application or package, or a problem while using software. When a software application encounters an error, a solution modeling subsystem assembles diagnostic data describing the error, the state of the software application leading up to the error, and any other data relevant to the error, and transmits the diagnostic data to a problem resolution manager. A problem resolution manager applies the diagnostic data to the facts of a particular scenario, and identifies an algorithm that is likely to be the most predictive for that scenario in order to resolve the problem.

However, the task of solving the problems experienced in the software products remains quite challenging. Indeed, this task is substantially a manual activity, which may require a deep investigation to identify the diagnostic information that may be actually useful (so that the quality of the obtained results strongly depends on personal skills of the operators).

In any case, any solution is applied after the corresponding problem has been experienced; particularly, in the above-mentioned scenario this happens only after the problem has occurred, has been recognized by the customer and then a support request thereof has been submitted to the customer support center.

All of the above may adversely affect operation of the software products, with corresponding negative side effects on business aspects relating thereto (for example, productivity, customer satisfaction).

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for managing problems in a software product installed on a plurality of computing machines. The illustrative embodiment retrieves tracking information of one or more problems being solved on corresponding ones of the plurality of computing machines, for each of the one or more problems the tracking information comprising an indication of a solution applied to the problem on the corresponding computing machine and a set of tracking values of one or more diagnostic parameters of the corresponding computing machine. The illustrative embodiment establishes one or more solution models according to the tracking information, each solution model comprising an indication of a applied solution, an indication of a problem the solution was applied to, and one of the set of tracking values of the diagnostic parameters of the problem. The illustrative embodiment collects corresponding diagnostic reports from the computing machines according to the solution models, the diagnostic report of each computing machine comprising an indication of any of the problems of the solution models occurred on the computing machine and a set of collected values of any diagnostic parameters of the solution models available on the computing machine. The illustrative embodiment determines any applicable solutions from the solutions of the solution models for each of the computing machines according to a comparison of the diagnostic report of the computing machine with the solution models. The illustrative embodiment causes each computing machine to apply the corresponding applicable solutions.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The solution of the present disclosure, as well as further features and the advantages thereof, will be best understood with reference to the following detailed description thereof, given purely by way of a non-restrictive indication, to be read in conjunction with the accompanying drawings (where, for the sake of simplicity, corresponding elements are denoted with equal or similar references and their explanation is not repeated, and the name of each entity is generally used to denote both its type and its attributes—such as value, content and representation). Particularly:

FIG. 1A-FIG. 1D show the general principles of the solution according to an embodiment of the present disclosure;

FIG. 2 shows a schematic block diagram of a computing system wherein the solution according to an embodiment of the present disclosure may be practiced;

FIG. 3 shows the main software components that may be used to implement the solution according to an embodiment of the present disclosure; and

FIG. 4A-FIG. 4C show an activity diagram describing the flow of activities relating to an implementation of the solution according to an embodiment of the present disclosure.

### DETAILED DESCRIPTION

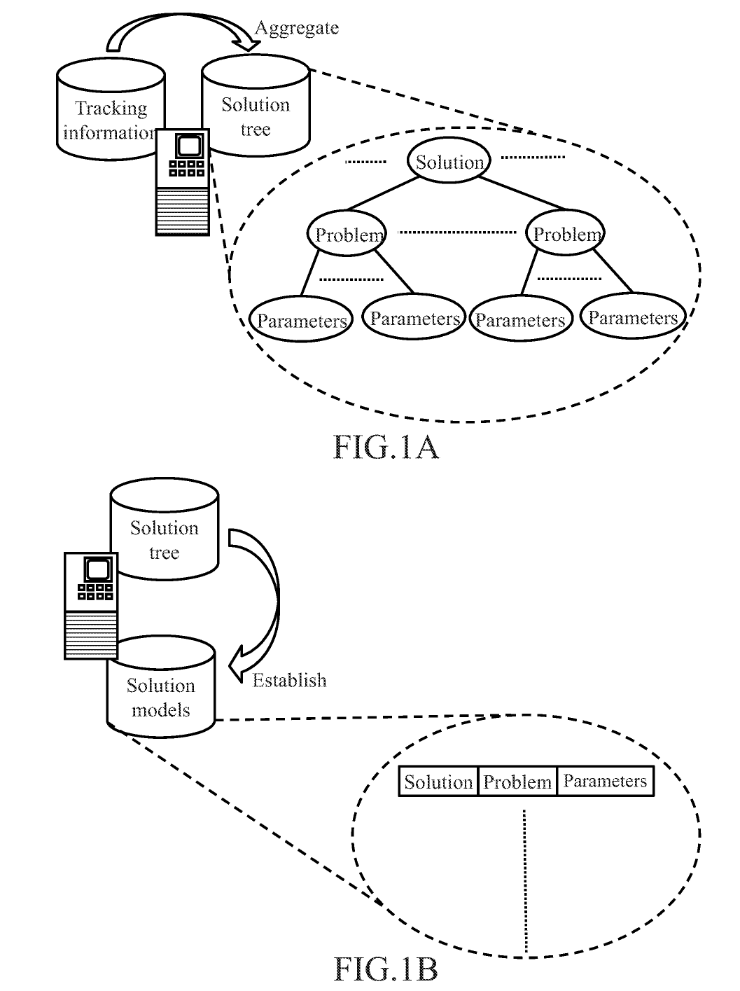

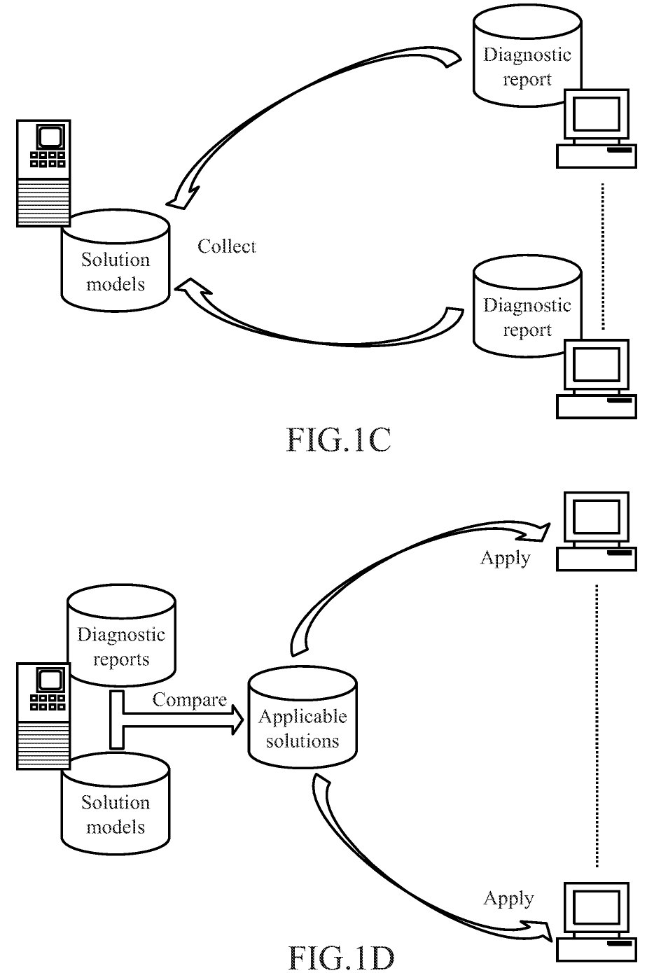

With reference in particular to FIG. 1A-FIG. 1D, the general principles are shown of the solution according to an embodiment of the present disclosure.

Starting from FIG. 1A, tracking information is available (for example, in a server of a customer support center). The tracking information is for one or more software products each one installed on a plurality of computing machines (for example, clients of corresponding customers). For each software product, the tracking information relates to one or more problems thereof that have been solved on corresponding clients; particularly, for each problem the tracking information comprises an indication of the solution that has been applied to the problem on the corresponding client (for example, a patch) and a set of (tracking) values of one or more diagnostic parameters of the corresponding client, referred to as tracking diagnostic parameters (for example, measures of configuration parameters, occurred local events).

The tracking information may be aggregated into a solution tree. Particularly, the tracking information is aggregated by the solutions. For each solution, the tracking information is then aggregated by the problems (solved by it); for each problem, the tracking information is then aggregated by the sets of tracking diagnostic parameters (of the clients wherein the problem has occurred). The solution tree then has a solution branch for each solution (starting from a root node); each solution branch comprises a sub-branch for each corresponding problem, which in turn comprises a sub-branch for each corresponding set of tracking diagnostic parameters.

Moving to FIG. 1B, one or more solution models are established according to the tracking information, for example, from the solution tree. Each solution model corresponds to a solution branch of the solution tree; particularly, the solution model comprises the indication of one of the solutions, the indication of one of the problems of the solution and one of the sets of tracking diagnostic parameters of the problem.

Moving to FIG. 1C, corresponding diagnostic reports are collected from the clients according to the solution models. Particularly, the diagnostic report of each client comprises an indication of any of the problems (among the ones indicated in the solution models) that have occurred on the client. Moreover, the diagnostic report comprises the (collected) values of any of the diagnostic parameters of the solution models that are available on the client, referred to as collected diagnostic parameters (i.e., the measures of the configuration parameters and the occurrences of the local events on the client).

Moving to FIG. 1D, any solutions that are applicable to each client is determined; the applicable solutions are determined, among the solutions of the solution models, according to a comparison of the diagnostic report of the client with the solution models; for example, the solution of a solution model is applicable to a client when the problem of the solution model has occurred on the client and the collected diagnostic parameters of the client are the same as the tracking diagnostic parameters of the solution model. The corresponding applicable solutions are then applied on each client (for example, after a manual confirmation).

The above-described solution provides a proactive approach to the management of the problems in the software products. For example, it is possible to solve any problem before any support request thereof has been submitted to the customer support center, for example, because its occurrence has not been recognized yet by the customer (in response to the match of both the problem and the set of tracking configuration parameters by the diagnostic report of the client). Moreover, it is possible to solve some problems even before they actually occur (in response to the match of the corresponding set of tracking configuration parameters by the diagnostic report of the client).

The proposed solution also simplifies the solution of any problems experienced in the software products. Indeed, in most cases the solutions to the problems are determined automatically, with no (or at least limited) human intervention; this provides a self-healing capability for the software products. In any case, the diagnostic reports that are collected from the clients are very useful for determining the solutions to the problems (and for determining the most critical areas of the software products); this avoids (or at least significant reduces) any investigation activity. As a result, the task of solving the problems is streamlined and made less dependent (or no dependent at all) on personal skills.

All of the above significantly improves operation of the software products, with corresponding positive effects on business aspects relating thereto; for example, this increases the productivity (for example, of end-users of the software products) and/or the customer satisfaction (for example, allowing meeting corresponding service level agreements).

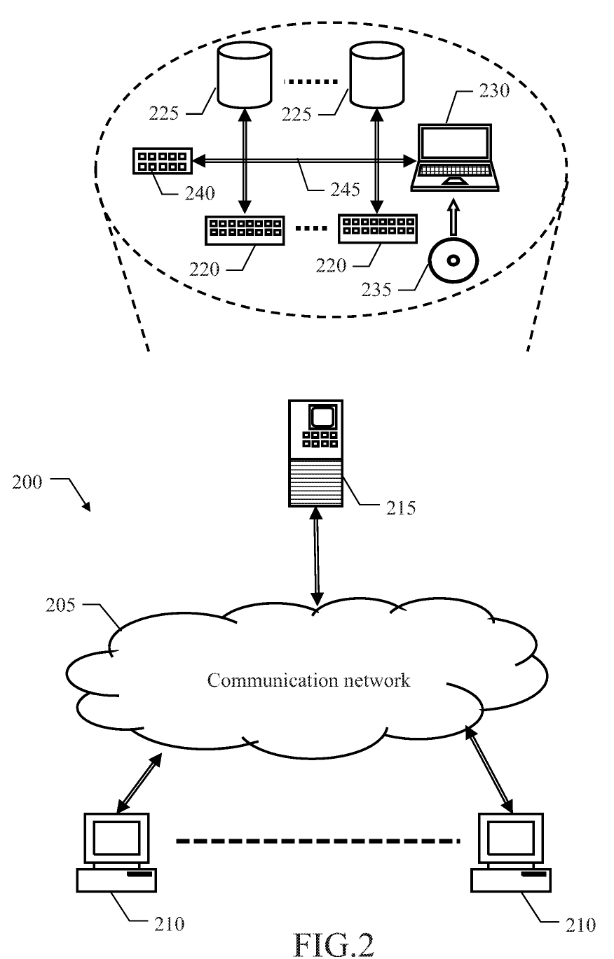

With reference now to FIG. 2, a schematic block diagram is shown of a computing system 200 wherein the solution according to an embodiment of the present disclosure may be practiced.

The computing system 200 has a distributed architecture based on a communication network 205 (for example, the Internet); several computing machines (for example, implemented in one or more data centers), are connected to the communication network 205. The software products to be managed according to an embodiment of the present disclosure are installed each one on a plurality of the computing machines, referred to as clients 210 (for example, used by customers of a vendor of the software products). Another one of the computing machines (or more), referred to as problem management server 215, controls the management of the problems in the software products (for example, in a customer support center of the vendor).

Each data center implementing the clients 210 and the problem management server 215 (only one shown in the figure) comprises several computing units 220 (for example, of the rack or blade type) and storage units 225 (for example, of the RAID type) implementing mass-memories thereof; in turn, each computing unit 220 comprises one or more microprocessors (μP) controlling its operation, a non-volatile memory (ROM) storing basic code for a bootstrap thereof and a volatile memory (RAM) used as a working memory by the microprocessors (not shown in the figure). The data center also comprises a console 230 for controlling it (for example, a personal computer, also provided with a drive for reading/writing removable storage units 235, such as optical disks like DVDs). A switch/router sub-system 240 manages any communications among the computing units 220, the storage units 225 and the console 230, and with the communication network 205; for this purpose, the computing units 220, the storage units 225 and the console 230 are connected to the switch/router sub-system 240 through a cabling sub-system 245.

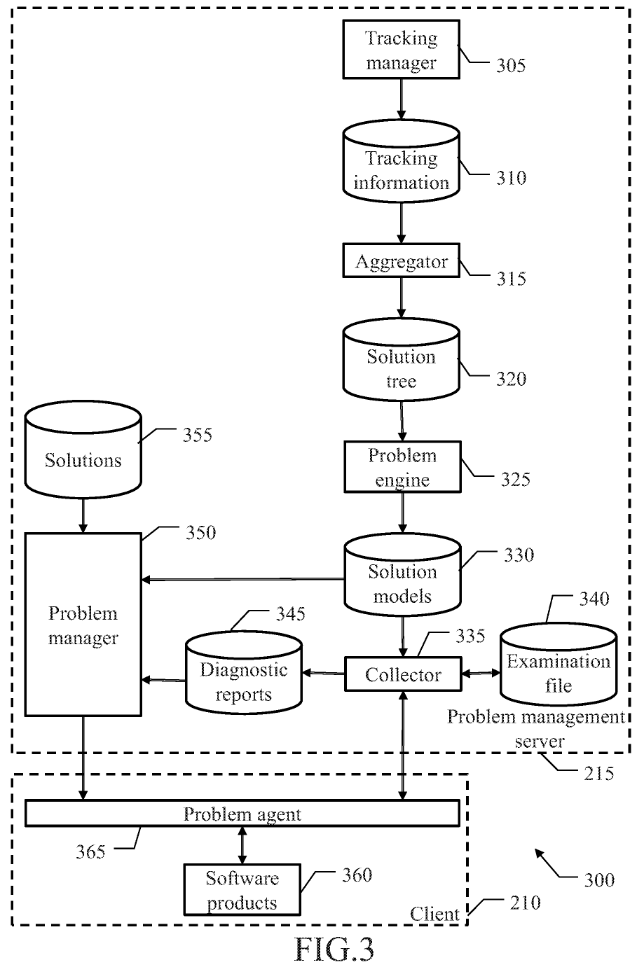

With reference now to FIG. 3, the main software components are shown that may be used to implement the solution according to an embodiment of the present disclosure.

All the software components (programs and data) are denoted as a whole with the reference 300. The software components are typically stored in the mass memory and loaded (at least partially) into the working memory of each computing machine when the programs are running, together with an operating system and other application programs (not shown in the figure). The programs are initially installed into the mass memory, for example, from removable storage units or from the communication network. In this respect, each program may be a module, segment or portion of code, which comprises one or more executable instructions for implementing the specified logical function.

Starting from the problem management server 215, it comprises the following components. A tracking manager 305 is used to manage diagnostic activities in the customer support center. The tracking manager 305 accesses (in read/write mode) a tracking information repository 310, which stores the tracking information for the diagnostic activities. Particularly, the tracking information (for example, in the CBE format) comprises a record for each ticket relating to a support request that has been received in the customer support center. The ticket indicates the customer that has submitted the support request (for example, its code, contact person), the problem that has been experienced (for example, its software product, problem code returned by the software product). The ticket indicates a set of (tracking) values of one or more hardware and/or software environment parameters of the client wherein the problem has occurred, referred to as tracking environment parameters (for example, machine model, operating system) and a set of (tracking) values of one or more diagnostic parameters (i.e., the tracking diagnostic parameters) that have been collected on the client for solving the problem; the diagnostic parameters may indicate hardware and/or software configuration parameters of the client (for example, user options, network connections) and/or local events that have occurred on the client (for example, warning messages). The ticket provides a running report of the management thereof (for example, a log of its opening, allocation, closure); particularly, when the ticket has been closed successfully, the ticket also indicates the solution that has been applied to the client to solve the problem (for example, by a solution code identifying a patch).

An aggregator 315 is used to aggregate the tracking information into the solution tree, for example, by leveraging a textual analyzer (not shown in the figure), like “Watson Explorer” by “IBM Corporation” (trademarks thereof). The aggregator 315 accesses (in read mode) the tracking information repository 310 and it accesses (in write mode) a solution tree repository 320, which stores the solution tree of each software product. The solution tree (for example, in the XML format) comprises a root node and a node depending thereon for each solution of the tickets that have been closed successfully (for example, containing its solution code). For each solution, one or more nodes depend on its node for each set of tracking environment parameters of the clients wherein the solution has been applied (for example, containing corresponding pairs type/value). For each set of tracking environment parameters, one or more nodes depend on its node for each problem that has been solved on the clients having the set of tracking environment parameters (for example, containing its problem code). For each problem, one or more (leaf) nodes depend on its node for each set of tracking diagnostic parameters of the clients wherein the problem has occurred (for example, containing corresponding pairs type/value); each leaf node also contains a weight of the corresponding solution branch (descending from the node of its solution to the leaf node in the solution tree), which weight is determined according to the occurrences of the corresponding data in the tracking information (for example, defined by a percentage of their tickets with respect to all the closed tickets of the software product).

A problem engine 325 is used to establish the solution models according to the solution tree. The problem engine 325 accesses (in read mode) the solution tree repository 320 and it accesses (in write mode) a solution model repository 330, which stores the solution models of each software product. Each solution model (for example, in the XML format) comprises an indication of one of the solutions (i.e., its solution code), one of the sets of tracking environment parameters of the clients wherein the solution has been applied, an indication of one of the problems (i.e., its problem code) that has been solved on the clients having the set of tracking environment parameters, one of the sets of tracking diagnostic parameters of the clients wherein the problem has occurred and the corresponding weight (corresponding to a solution branch); moreover, the solution model comprises an exclusion list that indicates any clients (by their client identifiers, for example, hostnames) wherein the application of the solution has been excluded because it has resulted ineffective in solving the problem.

A collector 335 is used to collect the diagnostic reports from the clients according to the solution models. The collector 335 accesses (in read mode) the solution model repository 330 and it accesses (in read/write mode) an examination file 340 for each software product. The examination file 340 (for example, in the XML format) comprises an examination record for each solution model. The examination record comprises an indication of the solution (i.e., its solution code), the set of tracking environment parameters, an indication of the problem (i.e., its problem code) and the exclusion list; moreover, the examination record comprises one or more instructions (for example, commands to be submitted to the operating system) for collecting the environment parameters, for determining any application of the solution, for determining any occurrence of the problem and for collecting the diagnostic parameters (i.e., for measuring the configuration parameters and for determining any occurrence of the local events) on the clients. Moreover, the collector 335 accesses (in write mode) a diagnostic report repository 345, which stores the diagnostic reports that have been collected from the clients according to the examination file 340 of each software product. Each diagnostic report comprises a diagnostic record for each examination record that is applicable thereon (according to its exclusion list and to its set of tracking environment parameters); the diagnostic record comprises a problem field indicating whether the problem has occurred on the client and in any case it comprises the collected diagnostic parameters of the client, i.e., the measures of the configuration parameters and any occurrences of the local events (for example, again in the form of corresponding pairs type/value).

A problem manager 350 is used to manage the problems of the clients. The problem manager 350 accesses (in read mode) the solution model repository 330, the diagnostic report repository 345 and a solution repository 355. The solution repository 350 (for example, in the XML format) stores one or more instructions (for example, commands to be submitted to the operating system) for applying each solution and for reversing its application, together with a corresponding package (for example, comprising the patch to be applied).

Moving to each client 210 (only one shown in the figure), it comprises the following components. One or more software products 360 of the vendor (i.e., instances thereof) that are supported by its customer support center are installed on the client 210. A problem agent 365 is used to manage the problems in the software products 360; for this purpose, the problem agent 365 interacts with the collector 335 (for collecting the diagnostic reports of the client 210) and it interacts with the problem manager 350 and with the software products 360 (for applying any applicable solutions thereto).

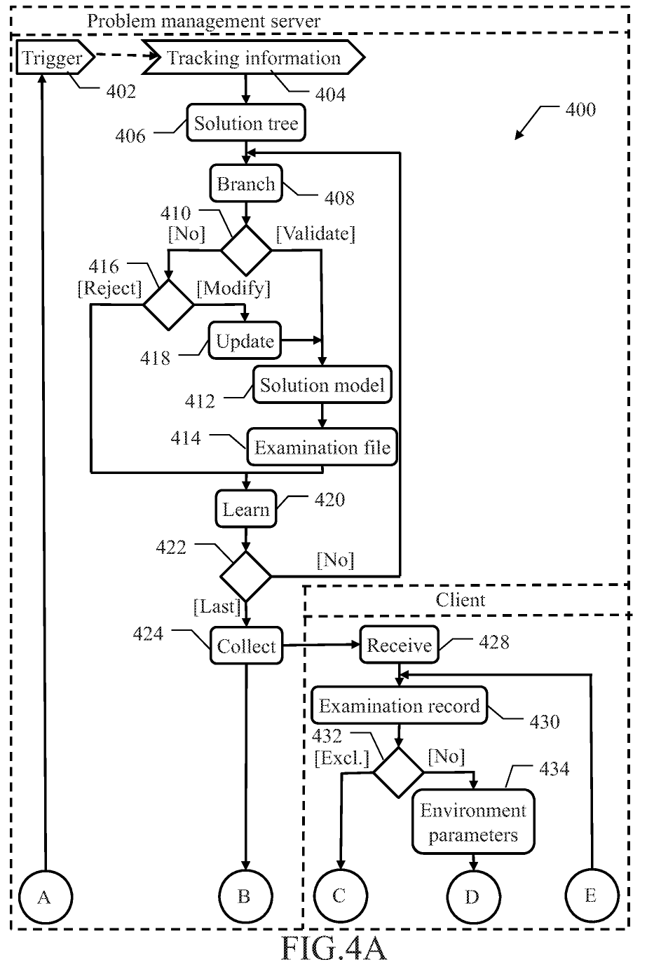

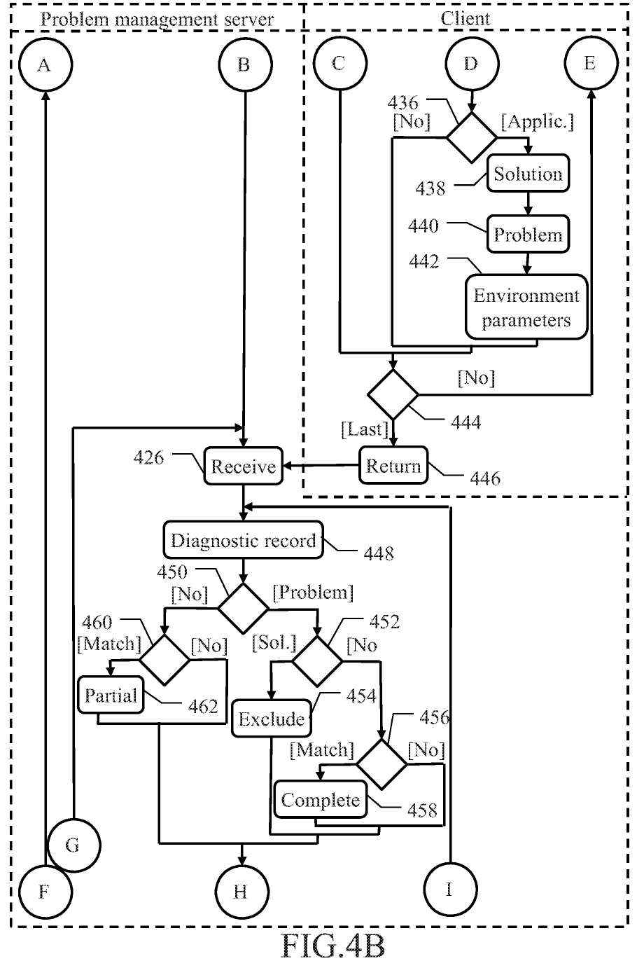

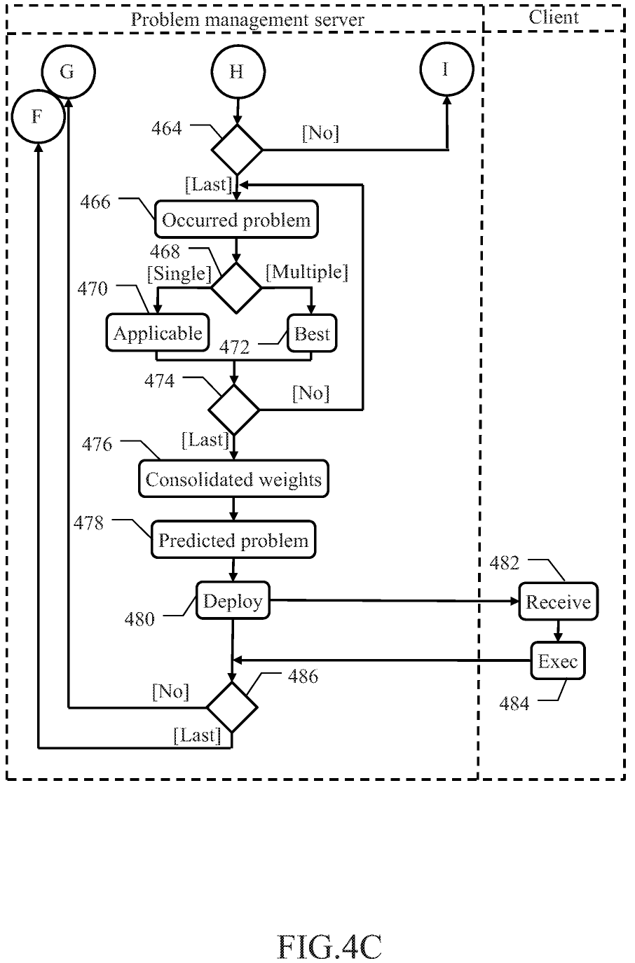

With reference now to FIG. 4A-FIG. 4C, an activity diagram is shown describing the flow of activities relating to an implementation of the solution according to an embodiment of the present disclosure.

Particularly, the diagram represents an exemplary process that may be used to manage the problems in a generic software product with a method 400. In this respect, each block may correspond to one or more executable instructions for implementing the specified logical function on the relevant one or more computing machines.

Starting from the swim-lane of the problem management server, the process passes from block 402 to block 404 as soon as an event triggering a management process of the problems occurs (for example, every time a time-out expires, such as every 1-5 minutes, every time a ticket is closed). In response thereto, the aggregator retrieves the up-to-date version of the tracking information (by accessing the corresponding repository). Continuing to block 406, the aggregator aggregates the tracking information into the solution tree (either in a complete mode or in an incremental mode) and saves it into the corresponding repository (only formed by the root node at the beginning in the complete mode). For example, for each ticket that has been closed, the aggregator verifies whether a node for its solution code (depending on the root node) exists in the solution tree. If not, a corresponding new solution branch (with its solution code, set of tracking environment parameters, problem code and set of tracking diagnostic parameters) is added and its weight is initialized to a starting value (for example, one). Otherwise, the aggregator verifies whether a node for the set of tracking environment parameters (depending on the node of the solution code) exists in the solution tree. If not, a corresponding new sub-branch (with its set of tracking environment parameters, problem code, set of tracking diagnostic parameters and initialized weight) is added. Otherwise, the aggregator verifies whether a node for the problem code (depending on the node of the set of tracking environment parameters) exists in the solution tree. If not, a corresponding new sub-branch (with its problem code, set of tracking diagnostic parameters and initialized weight) is added. Otherwise, the aggregator verifies whether a node for the set of tracking diagnostic parameters (depending on the node of the problem code) exists in the solution tree. If not, a corresponding new node (with its set of tracking diagnostic parameters and initialized weight) is added. Otherwise, the aggregator updates the corresponding weight accordingly (for example, by incrementing it by one).

A loop is then entered for establishing the solution models (either in a complete mode or in an incremental mode) according to the solution tree. The loop begins at block 408, wherein the problem engine takes a (current) solution branch into account (in any arbitrary order for all of them in the complete mode or only for the ones that have been updated in the incremental mode). The flow of activity branches at block 410 according to a validation of the solution branch. If the solution branch has been validated, the process descends into block 412; for example, this happens when the problem engine is configured in a manual mode for requesting a confirmation to a system operator and the system operator has accepted the solution branch, or it happens when the problem engine is configured in an automatic mode for operating without any human intervention and the weight of the solution branch reaches a validation threshold (for example, 1-10). In response thereto, the problem engine adds a new solution model for the solution branch to the corresponding repository (with its solution code, set of tracking environment parameters, problem code, set of tracking diagnostic parameters, weight and the exclusion list that is left empty). Continuing to block 414, the problem engine updates the examination file accordingly (empty at the beginning in the complete mode); particularly, the problem engine adds a new examination record with the solution code, the set of tracking environment parameters, the problem code and the exclusion list of the solution model and with the instructions for collecting the environment parameters, for determining any application of the solution, for determining any occurrence of the problem and for collecting the diagnostic parameters on the clients (for example, extracted from a pre-defined table for different values of the environment parameters). Returning again to the block 410, if the solution branch has not been validated (either manually or automatically), the process descends into block 416; at this point, the flow of activity further branches according to the type of missing validation of the solution branch. Particularly, if the solution branch may be validated in modified form the process descends into block 418; for example, this happens when the problem engine is configured in the manual mode and the system operator requests to update the solution branch for accepting it, or it may happen when the problem engine is configured in the automatic mode and one or more validation rules (learned as described in the following) that request to update the solution branch for accepting it apply thereto. In response thereto, the problem engine updates the solution branch as requested by the system operator or by the applicable validation rules (for example, removing a configuration parameter that is not relevant). The process then continues to the block 412 to repeat the same operations described above with the (updated) solution branch (so as to add a corresponding new solution model and a new examination record). The flow of activity merges again at block 420 from the block 414 or directly from the block 416 if the solution branch has been rejected; for example, this happens when the problem engine is configured in the manual mode and the system operator has not accepted the solution branch, or it happens when the problem engine is configured in the automatic mode and the weight of the solution branch does not reach the validation threshold or a corresponding validation rule applies. In any case, at this point the problem engine updates the validation rules (if necessary); for example, when the problem engine is configured in the manual mode a corresponding new validation rule is added after the system operator has requested the same updates or s/he has not accepted the same solution branch for a number of times reaching a learning threshold (for example, 1-5). In this way, the problem engine self-learns how to operate automatically. A test is then made at block 422, wherein the problem engine verifies whether a last solution branch has been processed. If not, the flow of activity returns to the block 408 to repeat the same operations for a next solution branch. Conversely, as soon as all the solution branches of the solution tree have been processed the above-described loop is exit by descending into block 424. At this point, the collector distributes the up-to-date version of the examination file to all the clients wherein the software product is installed (either entirely or as a delta with respect to a previous version thereof) for collecting the corresponding diagnostic reports. The collector than enters a waiting condition at block 426 for these diagnostic reports.

Moving to the swim-lane of each client (only one shown in the figure), the problem agent receives the examination file from the server management server at block 428 (for example, being listening for it). A loop is then entered for collecting the diagnostic report according to the examination file. The loop begins at block 430, wherein the problem agent takes a (current) examination record into account (in any arbitrary order). Continuing to block 432, the problem agent verifies whether the corresponding client identifier (for example, extracted from a system registry) is comprised in the exclusion list of the examination record. If not (meaning that the application of the examination record is not excluded on the client), the problem agent at block 434 executes the instructions of the examination record for collecting the values of the environment parameters defining the collected environment parameters. The flow of activity then branches at block 436 according to a comparison of the collected environment parameters with the tracking environment parameters of the examination record. If the collected environment parameters math the tracking environment parameters (meaning that the examination record is applicable to the client), the process descends into block 438; at this point, the problem agent adds a new diagnostic record to the diagnostic report (empty at the beginning); moreover, the diagnostic agent executes the instructions of the examination record for determining whether the solution has already been applied on the client. The problem agent at block 440 then executes the instructions of the examination record for determining whether the problem has occurred on the client, always or only after the application of the solution if it has been found; in response thereto, the problem agent sets the problem field of the new diagnostic record accordingly (for example, by writing the problem code of the problem when it has been found or a null value otherwise). The problem agent at block 442 executes the instructions of the examination record for collecting the diagnostic parameters defining the collected environment parameters; particularly, these instructions collect the values of any configuration parameters that are available on the client and determine whether any local events have occurred, as above always or only after the application of the solution if it has been found. In response thereto, the problem agent adds the collected diagnostic parameters to the new diagnostic record. The process then descends into block 444; the same point is also reached directly from the block 432 if the corresponding client identifier is comprised in the exclusion list of the examination record (meaning that the application of the examination record is excluded on the client) or from the block 436 if the collected environment parameters do not match the tracking environment parameters (meaning that the examination record is not applicable to the client). At this point, a test is made wherein the problem agent verifies whether a last examination record has been processed. If not, the flow of activity returns to the block 430 to repeat the same operations for a next examination record. Conversely, as soon as all the examination records of the examination file have been processed the above-described loop is exit by descending into block 446. The problem agent now returns the diagnostic report so obtained to the problem management server (with the problem agent that returns to a waiting condition for a next examination file at the block 428, not shown in the figure).

Referring back to the swim-lane of the problem management server, the process passes from the block 426 to block 448 as soon as the collector receives any diagnostic report from the clients (for example, being listening for it). At this point, a loop is entered for analyzing this diagnostic report; the loop begins with the problem manager that takes a (current) diagnostic record of the diagnostic report into account (in any arbitrary order). Continuing to block 450, the problem manager verifies the problem field of the diagnostic record. If the problem field comprises a problem code (meaning that the problem has occurred on the client, after the possible application of the solution of the corresponding solution model), the problem manager at block 452 verifies whether the solution of the corresponding solution model has already been applied on the client (for example, as indicated in a corresponding table or returned by the client in the diagnostic report). If so (meaning that the solution has been ineffective in solving the problem on the client), the problem manager at block 454 adds the client identifier of the client to the exclusion list of the solution problem (so as to exclude its application to the client in the future); at the same time, the problem manager adds the instructions for reversing the application of the solution of the (excluded) solution problem (extracted from the solution repository) to the solution file for the client (empty at the beginning). In this way, the management process converges towards the solutions that are actually effective on each client, automatically determining which are the most useful experiences of the other clients that may be translated thereto. In addition, the problem manager may also update an accuracy index (null at the beginning) according to a frequency of the detection of the ineffective solutions (for example, equal to a running average of the time between each pair of consecutive ineffective solutions); this accuracy index may be used to switch between the manual mode and the automatic mode (for establishing the solution models) according to a comparison with an accuracy threshold. Returning to the block 452, if the solution of the corresponding solution model has not already been applied on the client, the problem manager at block 456 compares the collected diagnostic parameters with the tracking diagnostic parameters of the corresponding solution model. If the collected diagnostic parameters match the tracking diagnostic parameters, the problem manager at block 458 sets the solution model as completely-matched by the diagnostic report (for example, asserting a corresponding flag associated therewith). Referring back to the block 450, if the problem field comprises the null value (meaning that the problem has not occurred on the client, after the possible application of the solution of the corresponding solution model) the problem manager at block 460 as above compares the collected diagnostic parameters with the tracking diagnostic parameters of the corresponding solution model. If the collected diagnostic parameters match the tracking diagnostic parameters, the problem manager at block 462 sets the solution model as partially-matched by the diagnostic report (for example, asserting a corresponding flag associated therewith). The flow of activity then merges again at block 464 from the block 454, from the block 458, from the block 462, or directly from the block 456 or the block 460 if the collected diagnostic parameters do not match the tracking diagnostic parameters (meaning that the corresponding solution model is not matched by the diagnostic report). At this point, a test is made wherein the problem manager verifies whether a last diagnostic record has been processed. If not, the flow of activity returns to the block 448 to repeat the same operations for a next diagnostic record. Conversely, as soon as all the diagnostic records of the diagnostic report have been processed the above-described loop is exit by descending into block 466.

A loop is now entered for processing the completely-matched solution models; the loop begins with the problem manager that takes a (current) problem of the completely-matched solution models into account (in any arbitrary order) and determines a number of the completely-matched solution models for this problem. The flow of activity then branches at block 468 accordingly. If a single completely-matched solution model has been found, the problem manager at block 470 sets the corresponding solution as applicable on the client; therefore, the problem manager adds the instructions for applying the solution (extracted from the solution repository) to the solution file for the client. Indeed, in this case the problem has occurred on the client in a condition (defined by the set of collected diagnostic parameters) the same as the condition of other clients (defined by the set of tracking diagnostic parameters) wherein the same problem has already been solved by the same solution; therefore, this solution should be effective in solving the problem in the client as well. Referring back to the block 468, if multiple completely-matched solution models have been found, the problem manager at block 472 verifies whether one of them may be selected as the best one for the problem; for example, this happens when one of completely-matched solution models has the weight that significantly exceeds the weights of the other ones (such as by at least 2-4 times). If so, the problem manager sets the solution of this (best) completely-matched solution model as applicable on the client as above (by adding the instructions for applying it to the solution file for the client); indeed, in most cases the problem has been solved by this solution, so that it is very likely that it will be effective in solving the problem in the client as well. Conversely, no solution of the completely-matched solution models is applicable on the client with an acceptable degree of confidence, so that the problem manager waits for next iterations of the management process. The flow of activity merges again at block 474 from the block 470 or from the block 472. At this point, a test is made wherein the problem manager verifies whether a last problem of the completely-matched solution models has been processed. If not, the flow of activity returns to the block 466 to repeat the same operations for a next problem of the completely-matched solution models. Conversely, as soon as all the completely-matched solution models have been processed the above-described loop is exit by descending into block 476.

The problem manager now processes the partially-matched solution models. Particularly, the problem manager at first consolidates the weights of the solutions of the partially-matched solution models (for example, by summing the weights of the same solutions), so has to have a single total weight for each solution. Continuing to block 478, the problem manager verifies whether any solutions of the partially-matched solution models may be selected as the best ones; for example, this happens when one of solutions of the partially-matched solution models (or more) has the total weight that significantly exceeds the total weights of the other ones (such as by at least 3-6 times). If so, the problem manager sets this (best) solution of the partially-matched solution models as applicable on the client (adding the instructions for applying it to the solution file for the client). Indeed, in this case the client is in a condition (defined by the set of collected diagnostic parameters) the same as the condition of other clients (defined by the set of tracking diagnostic parameters) wherein the same solution has been applied many times to solve the corresponding problem; therefore, it is very likely that the same problem will occur on the client as well in the future and that the solution is effective in solving it in advance. In this way, it is possible to predict and solve the problems before they actually occur on the client. Continuing to block 480, the problem manager deploy the solution file to the corresponding client.

Moving to the swim-lane of the client, the problem agent receives the solution file from the problem management server at block 482 (for example, being listening for it). In response thereto, the problem agent at block 484 executes the instructions contained therein in succession, so as to apply or reverse the (previous) application of the corresponding solutions. These operations may be performed either automatically or requesting a manual confirmation by a user of the client, and generally end returning a result thereof to the problem management server (with the problem agent that returns to a waiting condition for a next solution file at the block 482, not shown in the figure).

Referring back to the swim-lane of the problem management server, at the same time the flow of activity descends from the block 480 to block 486, wherein the problem manager verifies whether the diagnostic reports have been received from all the clients. If not, the process returns to the block 426 waiting for a next diagnostic report. Conversely, as soon as the diagnostic reports have been received from all the clients (or in any case after a predetermined delay from the distribution of the examination file, for example, 1-5 minutes), the flow of activity returns to the block 402 waiting for a next event triggering the management process.

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may even be practiced without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. In any case, each numerical value should be read as modified by the term about (unless already done) and each range of numerical values should be intended as expressly specifying any possible number along the continuum within the range (comprising its end points). Moreover, ordinal or other qualifiers are merely used as labels to distinguish elements with the same name but do not by themselves connote any priority, precedence or order. The terms include, comprise, have, contain and involve (and any forms thereof) should be intended with an open, non-exhaustive meaning (i.e., not limited to the recited items), the terms based on, dependent on, according to, function of (and any forms thereof) should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a method for managing problems in a software product installed on a plurality of computing machines. However, the problems may be in any number and of any type (for example, errors, warnings, either temporary or permanent, experienced during the installation or the use of the software product); the method may be applied to any number and type of software products (for example, application programs, middleware programs, operating systems) that are installed on any number and type of physical and/or virtual computing machines (for example, clients, servers, cloud nodes).

In an embodiment, the method comprises retrieving tracking information of one or more problems being solved on corresponding ones of the computing machines. However, the tracking information may be of any type (for example, relating to customers of a vendor, users of a company) and it may relate to any number of problems solved on any number of computing machines (for example, all of them or selected ones according to any criterion like the country).

In an embodiment, for each of the problems the tracking information comprises an indication of a solution applied to the problem on the corresponding computing machine. However, the solution may be indicated in any way (for example, by a link thereto) and it may be of any type (for example, a patch, a script, manual instructions).

In an embodiment, for each of the problems the tracking information comprises a set of tracking values of one or more diagnostic parameters of the corresponding computing machine. However, the diagnostic parameters may be in any number and of any type (for example, configuration parameters, local events, performance parameters, co-installed software products or any combination thereof).

In an embodiment, the method comprises establishing one or more solution models according to the tracking information. However, the solution models may be in any number and established in any way (for example, manually, automatically, semi-automatically, with or without taking into account the corresponding weights), either aggregating the tracking information into the solution tree in any way (for example, according to single values and/or ranges of the diagnostic parameters) or directly from the tracking information.

In an embodiment, each solution model comprises the indication of one of the solutions, the indication of one of the problems of the solution and one of the sets of tracking values of the diagnostic parameters of the problem. However, each solution model may be of any type (for example, with or without the weight and the exclusion list).

In an embodiment, the method comprises collecting corresponding diagnostic reports from the computing machines according to the solution models. However, the diagnostic reports may be collected in any way (for example, in push or pull mode, for determining whether any problem has occurred independently or not of the application of the corresponding solution).

In an embodiment, the diagnostic report of each computing machine comprises an indication of any of the problems of the solution models occurred on the computing machine and a set of collected values of any diagnostic parameters of the solution models available on the computing machine. However, the diagnostic report may be of any type (for example, with or without a reference to the corresponding solution model, with a timestamp of any occurrences of the problems and/or of the local events, with the corresponding set of collected diagnostic parameters only when the occurrence of each problem has been detected).

In an embodiment, the method comprises determining any applicable solutions (of the solutions of the solution models) for each of the computing machines according to a comparison of the diagnostic report of the computing machine with the solution models. However, the applicable solutions may be determined in any way (for example, only for the single completely-matched solution models or for the multiple completely-matched solution models, for the predicted problems as well).

In an embodiment, the method comprises causing each computing machine to apply the corresponding applicable solutions. However, the applicable solutions may be applied in any way (for example, enforced centrally, with a policy-based approach, automatically, semi-automatically, manually).

In an embodiment, the method comprises retrieving the tracking information further comprising a set of tracking values of one or more environment parameters of the corresponding computing machine for each of the problems. However, the environment parameters may be in any number and of any type (for example, hardware parameters like machine model, microprocessor frequency, available memory and/or software parameters like operating system, version, service level, in either cases defined by single values and/or ranges); in any case, the possibility is not excluded of treating the environment parameters simply as additional diagnostic parameters.

In an embodiment, the method comprises establishing the solution models each one to further comprise the corresponding sets of tracking values of the environment parameters. However, this information may be added in any way (for example, by creating corresponding groups of solution models for the different sets of tracking values of the environment parameters).

In an embodiment, the method comprises collecting the diagnostic report from each of the computing machines by filtering the solution models according to a match of a set of collected values of the environment parameters available on the computing machine with the set of tracking values of the environment parameters. However, the solution models may be filtered in any way (for example, by the problem management server or by each client) according to any match of the collected values with the tracking values of the environment parameters (for example, same values or values comprised in ranges).

In an embodiment, the diagnostic parameters comprise one or more configuration parameters of the corresponding computing machine. However, the configuration parameters may be in any number and or any type (for example, relating to the operating system, the software product).

In an embodiment, in addition or in alternative the diagnostic parameters comprise an indication of one or more local events occurred on the corresponding computing machine. However, the local events may be in any number and of any type (for example, extracted from a system log, a product log).

In an embodiment, the step of determining any applicable solutions comprises, for each computing machine, determining any completely-matched solution models (of the solution models) having the problem and the set of tracking values of the diagnostic parameters matched by the diagnostic report of the computing machine. However, the completely-matched solution models may be determined according to any match (for example, when the information of the diagnostic report is equal or comprised in the corresponding information of the solution models).

In an embodiment, the step of determining any applicable solutions comprises, for each computing machine, determining one of the applicable solutions (for each of the problems of the completely-matched solution models comprised in a single one of the completely-matched solution models) equal to the solution of the single completely-matched solution model. However, these applicable solutions may be taken into account indiscriminately or selectively (for example, only for a best one of the completely-matched solution models according to their weights).

In an embodiment, the step of determining any applicable solutions comprises, for each computing machine, determining a further one of the applicable solutions (for each of the problems of the completely-matched solution models comprised in multiple ones of the completely-matched solution models) equal to the solution of a selected one of the multiple completely-matched solution models. However, the completely-matched solution models may be selected in any way (for example, according to the weights, to a matching rate of the diagnostic parameters or to any combination thereof); in any case, this feature may also be omitted (always or according to the accuracy level).

In an embodiment, the method comprises assigning a weight to each of the solution models according to occurrences thereof in the tracking information. However, the weights may be calculated in any way (for example, as a total number, a percentage, according to corresponding feedbacks).

In an embodiment, the step of determining a further one of the applicable solutions comprises selecting one of the multiple completely-matched solution models for each of the problems according to the corresponding weights. However, the selection may be performed in any way (for example, according to all the weights individually, to the total weights of the problems, to the highest weights of the problems).

In an embodiment, the method comprises excluding each of the solution models from application on each of the computing machines in response to at least one further occurrence of the problem of the solution model on the computing machine after the application of the solution of the solution model on the computing machine. However, the solution model may be excluded in any way (for example, by the problem management server or by each client) and according to any further occurrences of the problem (for example, after the first occurrence, after any number of consecutive occurrences, always or only when close to each other, immediately after the application of the solution or after a predefined delay therefrom); moreover, this operation may be performed automatically, with a manual confirmation or it may also be omitted at all.

In an embodiment, the step of excluding each of the solution models comprises detecting each of the at least one further occurrence of the problem of the solution model in response to the solution model having the problem matched by the diagnostic report of the computing machine. However, the further occurrence of the problem may be detected in any way (for example, by dedicated commands independently of the collection of the diagnostic reports).

In an embodiment, the method comprises causing each computing machine to reverse the application of each of the applicable solutions in response to the exclusion of the solution model of the applicable solution from application on the computing machine. However, the application of the solution may be reversed in any way (either the same or different with respect to its application); in any case, additional, alternative or different operations may be performed for the excluded solution (for example, with or without reversing its application).

In an embodiment, the step of determining any applicable solutions comprises, for each computing machine, determining any partially-matched solution models (of the solution models) having the set of tracking values of the configuration parameters matched by the diagnostic report of the computing machine. However, the partially-matched solution models may be determined according to any match of the diagnostic parameters (either the same or different with respect to the completely-matched solution models).

In an embodiment, the step of determining any applicable solutions comprises, for each computing machine, setting at least one of the solutions of the partially-matched solution models as one of the applicable solutions. However, these applicable solutions may be determined in any way (from a single one to all of them, selected in any way, for example, according to the weights, to a matching rate of the diagnostic parameters or to any combination thereof).

In an embodiment, the step of setting at least one of the solutions comprises setting at least one of the solutions of the partially-matched solution models as one of the applicable solutions according to the corresponding weights. However, the selection may be performed in any way (for example, according to all the weights individually, to the total weights of the solutions, to the highest weights of the solutions).

In an embodiment, the step of setting at least one of the solutions comprises consolidating the weights of the partially-matched solution models by the solutions. However, the weights may be consolidated in any way (for example, by calculating their sum, average, median).

In an embodiment, the step of setting at least one of the solutions comprises setting at least one of the solutions of the partially-matched solution models as one of the applicable solutions according to the corresponding consolidated weights. However, these applicable solutions may be determined in any way (see above).

In an embodiment, the method comprises receiving corresponding manual validations of the solution models. However, the validations may be of any type (for example, accepting/rejecting with or without the possibility of updating the solution models).

In an embodiment, the method comprises learning one or more validation rules according to the manual validations. However, the validation rules may be in any number and of any type (for example, for accepting, rejecting and/or updating the solution models in any way, like by refusing specific combinations of diagnostic parameters, determined after any number of consecutive occurrences of the manual validations, always or only when close to each other, either automatically or requesting a manual confirmation).

In an embodiment, the method comprises validating each solution model according to the validation rules. However, the validation rules may be used in any way (for example, to validate the solution models automatically or as a simple suggestion); in any case, the solution models may be validated in any way (for example, manually, automatically or semi-automatically, with the type that is fixed, configurable or changing dynamically according to any accuracy index).

Generally, similar considerations apply if the same solution is implemented with an equivalent method (by using similar steps with the same functions of more steps or portions thereof, removing some steps being non-essential, or adding further optional steps); moreover, the steps may be performed in a different order, concurrently or in an interleaved way (at least in part).

An embodiment provides a computer program configured for causing a computing system to perform the above-mentioned method when the computer program is executed on the computing system. An embodiment provides a computer program product, the computer program product comprising a computer readable storage medium having program instructions embodied therewith, the program instructions being executable by a computing system to cause the computing system to perform the same method. However, the computer program may be implemented as a stand-alone module, as a plug-in for a pre-existing computer program (for example, the tracking manager), or even directly in it; moreover, the computer program may run on any computing system (see below). In any case, the solution according to an embodiment of the present disclosure lends itself to be implemented even with a hardware structure (for example, by electronic circuits integrated in one or more chips of semiconductor material), or with a combination of software and hardware suitably programmed or otherwise configured.

An embodiment provides a system comprising means configured for performing each of the steps of each of the above-mentioned method. An embodiment provides a system comprising a circuitry (i.e., any hardware suitably configured, for example, by software) configured for performing each of the steps of the same method. However, the system may be of any type (for example, any physical and/or virtual computing machine communicating with the computing machines wherein the software product is installed via any local, wide area, global, cellular or satellite network and exploiting any type of wired and/or wireless connections or even hosted on a same virtualized environment).

Generally, similar considerations apply if the system has a different structure or comprises equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interactivity between different components generally does not need to be continuous, and it may be either direct or indirect through one or more intermediaries.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for managing problems in a software product installed on a plurality of computing machines, wherein the method comprises:
retrieving tracking information of one or more problems being solved on corresponding ones of the plurality of computing machines, for each of the one or more problems the tracking information comprising an indication of a solution applied to the problem on the corresponding computing machine and a set of tracking values of one or more diagnostic parameters of the corresponding computing machine;
establishing one or more solution models according to the tracking information, each solution model comprising an indication of a applied solution, an indication of a problem the solution was applied to, and one of the set of tracking values of the diagnostic parameters of the problem;
collecting corresponding diagnostic reports from the computing machines according to the solution models, the diagnostic report of each computing machine comprising an indication of any of the problems of the solution models occurred on the computing machine and a set of collected values of any diagnostic parameters of the solution models available on the computing machine;
determining any applicable solutions from the solutions of the solution models for each of the computing machines according to a comparison of the diagnostic report of the computing machine with the solution models; and
causing each computing machine to apply the corresponding applicable solutions.

2. The method of claim 1, further comprising:
retrieving the tracking information further comprising a set of tracking values of one or more environment parameters of the corresponding computing machine for each of the problems;
establishing the solution models each one to further comprise the corresponding sets of tracking values of the environment parameters; and
collecting the diagnostic report from each of the computing machines by filtering the solution models according to a match of a set of collected values of the environment parameters of the solution models available on the computing machine with the set of tracking values of the environment parameters.

3. The method of claim 1, wherein the diagnostic parameters comprise one or more configuration parameters of the corresponding computing machine and/or an indication of one or more local events occurred on the corresponding computing machine.

4. The method of claim 1, wherein the determining of any applicable solutions further comprises, for each computing machine:
determining any completely-matched solution models of the solution models having the problem and the set of tracking values of the diagnostic parameters matched by the diagnostic report of the computing machine; and
determining one of the applicable solutions, for each of the problems of the completely-matched solution models comprised in a single one of the completely-matched solution models, equal to the solution of the single completely-matched solution model.

5. The method of claim 4, wherein the determining of any applicable solutions further comprises, for each computing machine:
determining a further one of the applicable solutions, for each of the problems of the completely-matched solution models comprised in multiple ones of the completely-matched solution models, equal to the solution of a selected one of the multiple completely-matched solution models.

6. The method of claim 5, further comprising:
assigning a weight to each of the solution models according to occurrences thereof in the tracking information, wherein the determining of the further one of the applicable solutions comprises:
selecting one of the multiple completely-matched solution models for each of the problems according to the corresponding weights.

7. The method of claim 1, further comprising:
excluding each of the solution models from application on each of the computing machines in response to at least one further occurrence of the problem of the solution model on the computing machine after the application of the solution of the solution model on the computing machine.

8. The method of claim 7, wherein the excluding of each of the solution models comprises:
detecting each of the at least one further occurrence of the problem of the solution model in response to the solution model having the problem matched by the diagnostic report of the computing machine.

9. The method of claim 7, further comprising:
causing each computing machine to reverse the application of each of the applicable solutions in response to the exclusion of the solution model of the applicable solution from application on the computing machine.

10. The method of claim 1, wherein the determining of any applicable solutions further comprises, for each computing machine:
determining any partially-matched solution models of the solution models having the set of tracking values of the configuration parameters matched by the diagnostic report of the computing machine; and
setting at least one of the solutions of the partially-matched solution models as one of the applicable solutions.

11. The method of claim 10, further comprising:
assigning a weight to each of the solution models according to occurrences thereof in the tracking information, wherein the setting of the at least one of the solutions comprises:
setting at least one of the solutions of the partially-matched solution models as one of the applicable solutions according to the corresponding weights.

12. The method according to claim 11, wherein said setting at least one of the solutions comprises:
consolidating the weights of the partially-matched solution models by the solutions, and
setting at least one of the solutions of the partially-matched solution models as one of the applicable solutions according to the corresponding consolidated weights.

13. The method according to claim 1, wherein the method comprises:
receiving corresponding manual validations of the solution models;
learning one or more validation rules according to the manual validations; and
validating each solution model according to the validation rules.

14. A computer program product comprising a computer readable storage medium having a computer readable program for managing problems in a software product installed on a plurality of computing machines stored therein, wherein the computer readable program, when executed on a computing device, causes the computing device to:
retrieve tracking information of one or more problems being solved on corresponding ones of the plurality of computing machines, for each of the one or more problems the tracking information comprising an indication of a solution applied to the problem on the corresponding computing machine and a set of tracking values of one or more diagnostic parameters of the corresponding computing machine;
establish one or more solution models according to the tracking information, each solution model comprising an indication of a applied solution, an indication of a problem the solution was applied to, and one of the set of tracking values of the diagnostic parameters of the problem;
collect corresponding diagnostic reports from the computing machines according to the solution models, the diagnostic report of each computing machine comprising an indication of any of the problems of the solution models occurred on the computing machine and a set of collected values of any diagnostic parameters of the solution models available on the computing machine;
determine any applicable solutions from the solutions of the solution models for each of the computing machines according to a comparison of the diagnostic report of the computing machine with the solution models; and
cause each computing machine to apply the corresponding applicable solutions.

15. The computer program product of claim 14, wherein the computer readable program further causes the computing device to:
retrieve the tracking information further comprising a set of tracking values of one or more environment parameters of the corresponding computing machine for each of the problems;
establish the solution models each one to further comprise the corresponding sets of tracking values of the environment parameters; and
collect the diagnostic report from each of the computing machines by filtering the solution models according to a match of a set of collected values of the environment parameters of the solution models available on the computing machine with the set of tracking values of the environment parameters.

16. The computer program product of claim 14, wherein the computer readable program for determining of any applicable solutions further causes the computing device to, for each computing machine:
determine any completely-matched solution models of the solution models having the problem and the set of tracking values of the diagnostic parameters matched by the diagnostic report of the computing machine; and
determine one of the applicable solutions, for each of the problems of the completely-matched solution models comprised in a single one of the completely-matched solution models, equal to the solution of the single completely-matched solution model.

17. The computer program product of claim 14, wherein the computer readable program further causes the computing device to:
exclude each of the solution models from application on each of the computing machines in response to at least one further occurrence of the problem of the solution model on the computing machine after the application of the solution of the solution model on the computing machine.

18. The computer program product of claim 14, wherein the computer readable program for determining of any applicable solutions further causes the computing device to, for each computing machine:
determine any partially-matched solution models of the solution models having the set of tracking values of the configuration parameters matched by the diagnostic report of the computing machine; and
set at least one of the solutions of the partially-matched solution models as one of the applicable solutions.

19. The computer program product of claim 14, wherein the computer readable program further causes the computing device to:
receive corresponding manual validations of the solution models;
learn one or more validation rules according to the manual validations; and
validate each solution model according to the validation rules.

20. An apparatus for managing problems in a software product installed on a plurality of computing machines comprising:
a processor; and
a memory coupled to the processor, wherein the memory comprises instructions which, when executed by the processor, cause the processor to:
retrieve tracking information of one or more problems being solved on corresponding ones of the plurality of computing machines, for each of the one or more problems the tracking information comprising an indication of a solution applied to the problem on the corresponding computing machine and a set of tracking values of one or more diagnostic parameters of the corresponding computing machine;
establish one or more solution models according to the tracking information, each solution model comprising an indication of a applied solution, an indication of a problem the solution was applied to, and one of the set of tracking values of the diagnostic parameters of the problem;
collect corresponding diagnostic reports from the computing machines according to the solution models, the diagnostic report of each computing machine comprising an indication of any of the problems of the solution models occurred on the computing machine and a set of collected values of any diagnostic parameters of the solution models available on the computing machine;
determine any applicable solutions from the solutions of the solution models for each of the computing machines according to a comparison of the diagnostic report of the computing machine with the solution models; and
cause each computing machine to apply the corresponding applicable solutions.
